(19) United States
(12) Patent Application Publication
(10) Pub. No.: US 2012/0275485 A1
(43) Pub. Date: Nov. 1, 2012

(54) Cargo Deck For A Cargo Hold Of An Aircraft And Method For Monitoring The Temperature Of A Container, A Pallet Or A Similar Unit Load Device (ULD) Disposed On A Cargo Hold Floor

(75) Inventors: Richard Holzner, Stephanskirchen (DE); Benedikt Kieser, Hausham (DE); Martin Schmidseder, Brannenburg (DE); Thomas Huber, Schliersee (DE)

(73) Assignee: Telair International GmbH, Miesbach (DE)

(21) Appl. No.: 13/451,263

(22) Filed: Apr. 19, 2012

(30) Foreign Application Priority Data
Apr. 27, 2011 (DE) 10 2011 002 276.7

(51) Int. Cl. G01J 5/10; G01K 15/00

(52) U.S. Cl. 374/1; 374/121; 374/E15.001

(57) ABSTRACT

Disclosed is a cargo deck for a cargo hold of an aircraft, comprising at least one temperature measuring device for non-contacting measurement of the temperature of a container, a pallet or a similar unit load device (ULD).

### BACKGROUND

The invention relates to a cargo deck for a cargo hold of an aircraft according to claim 1 and a method for monitoring the temperature of a container, a pallet or a similar unit load device disposed on a cargo hold floor according to claim 11.

Nowadays, a large proportion of global freight is transported by aircraft. There is a high risk when transporting freight in aircraft that the freight will ignite and flames or a fire will break out as a result.

Although all aircraft have a smoke alarm system for the cargo hold, flames or a fire have already broken out when the smoke alarm system responds. Aircraft do not usually have any proper extinguishing system and rather attempts are made to more or less smother the fire or to reduce it as far as possible by means of air partitioning until the aircraft has landed again.

Therefore one problem is that flames or a fire that have already broken out during the flight lead to a huge and incalculable risk for the aircraft, the flight crew, passengers and other freight in the aircraft and have even resulted in aircraft crashes in the past.

The object of the invention is to disclose a cargo deck with which the danger of an imminent outbreak of flames or a fire can be detected before flames or a fire have broken out.

This object is achieved by a cargo deck for a cargo hold of an aircraft according to claim 1 and a method for monitoring the temperature of a container, a pallet or a similar unit load device disposed on a cargo hold floor according to claim 11.

In particular, the object is achieved by a cargo deck for a cargo hold of an aircraft, comprising at least one temperature measuring device for non-contacting measurement of the temperature of at least one container, pallet or similar unit load device (ULD).

A substantial point of the invention is that the temperature of the ULD is measured by means of the temperature measuring device such that a temperature or increase in temperature which indicates a risk of an imminent fire or flames can be recorded.

The advantage of this is that it is possible to record the development of intense heat which generally precedes a fire or flames. As a result of this, it is possible to initiate appropriate countermeasures if the temperature of the ULD is too high so that a fire or flames can be prevented. Even if it is no longer possible to prevent the outbreak of a fire or flames, it is still possible to initiate countermeasures and/or emergency measures against a fire or flames significantly earlier, even before a smoke alarm system detects smoke and triggers an alarm. This results in increased safety. Moreover, the temperature measuring device can also detect a fire or flames that already exist.

The temperature measuring device may include an infra-red sensor. This results in a reduction in costs. In addition, the technical effort decreases since the infra-red sensors can easily be installed and require less maintenance work.

In one embodiment, the temperature measuring device includes an infra-red camera. One advantage of this is a reduction in costs since infra-red cameras are inexpensive. In addition, an infra-red camera displays greater temperature accuracy under varying climatic conditions. Moreover, an infra-red camera can record a temperature curve profile of the ULD. This means that it is possible to detect the imminence of an outbreak of fire or flames even more accurately.

In another embodiment, the temperature measuring device is disposed in a floor of the cargo deck in such a way that the temperature of an underside of the ULD is measurable by means of the temperature measuring device. This arrangement considerably reduces disruptive environmental influences on the temperature measuring device. The accuracy and reliability of the temperature measurement increases as a result of this. In addition, the temperature measuring device is well protected against damage, in particular due to movements of the ULDs. Moreover, temperature recording is made easier in as much as the underside of each ULD is the same shape and therefore the spatial distribution of the thermal radiation of the underside of ULDs is essentially identical.

The temperature measuring device can be adapted for measuring the temperature of a substantially black underside of the ULD. The advantage of this is that temperature measurement by the temperature measuring device becomes even more precise since a black underside essentially has an emissivity of 1.

In another embodiment, the temperature measuring device is connectable to a data bus, in particular a CAN bus, of the cargo deck, in particular of the cargo hold floor, for the transmission of heat measurement signals. One advantage of this is that it is technically easy to transmit heat measuring signals, which are obtained by measuring the temperature of the ULD, to other devices. This makes monitoring of a plurality of containers in a cargo deck significantly easier.

The temperature measuring device may be connectable to an operations control centre. One advantage of this is that the temperature measurements of many different containers can be brought together in the operations control centre which means that the imminence of an outbreak of fire or flames or the existence of flames or a fire that are already present in the cargo deck can be detected even more easily. Moreover, it can be estimated in the operations control centre to what extent existing flames or an existing fire have already spread.

In another embodiment, the temperature measuring device can be calibrated and/or set to an emissivity of the material of the ULD, in particular of the material of the underside of the ULD. The advantage of this is that the accuracy of the temperature measurement can be increased by taking the emissivity of different materials of the ULD into consideration. Consequently, the accuracy of the temperature measurement can essentially be kept constant even in the case of ULDs with different materials.

In another embodiment, the cargo deck is characterised by at least one roller drive unit (PDU) for moving the ULD, wherein the temperature measuring device is disposed in the roller drive unit. The advantage of this is that the installation effort for the temperature measuring devices is reduced since the temperature measuring device is installed at the same time as the roller drive unit. hi addition, connection of the temperature measuring device to a data bus is made significantly easier since the roller drive unit is usually already connected to a data bus. Consequently, essentially no additional wiring is required in order to connect the temperature measuring device to a data bus. The PDU is also usually at a specifically defined distance from the ULD which means that the accuracy of the temperature measurement can be increased.

The temperature measuring device may be configured in such a way that the presence or absence of a ULD is ascertainable for control purposes by means of an output signal of the temperature measuring device. The advantage of this is both that the temperature of the ULD can be recorded and also the presence or absence of a ULD can be detected with a single device. This results in a reduction in costs and technical effort since only one device is required instead of two separate devices for temperature measurement and verification of the presence or absence of the ULD. This results in a reduction in costs and technical effort.

The object is also achieved by a method for monitoring the temperature of a container, a pallet or a similar unit load device (ULD) disposed on a cargo hold floor, wherein the temperature of the ULD, in particular the temperature of an underside of the ULD, preferably the temperature of a black underside of the ULD, is measured without physical contact by means of a temperature measuring device, in particular by at least one temperature measuring device in a roller drive unit for moving the ULD of the cargo hold floor.

By measuring the temperature of the ULD, it is possible to initiate appropriate countermeasures if the temperature of the ULD is too high such that a fire or flames can be prevented. Even if it is no longer possible to prevent the outbreak of a fire or flames, it is still possible to initiate countermeasures against a fire or flames significantly earlier. This results in increased safety. Moreover, this method can also detect a fire or flames that already exist. Measuring the temperature of a black underside of the ULD increases the accuracy of the temperature measurement since such an underside essentially has a emissivity of 1.

The temperature of the ULD can be measured by means of an infra-red sensor and/or an infra-red camera. This results in a reduction in costs. In addition, the technical effort decreases since the infra-red sensors can easily be installed and require less maintenance work. The costs decrease when measuring the temperature by means of infra-red camera since infra-red cameras are inexpensive. In addition, an infra-red camera displays greater temperature accuracy under varying climatic conditions. Moreover, a temperature curve profile of the ULD can be recorded by measuring with an infra-red camera. This means that it is possible to detect the imminence of an outbreak of fire or flames even more accurately.

A surface coating to increase the emissivity may be applied to an underside of the ULD prior to measuring the temperature. The advantage of this is a significant increase in the accuracy of the temperature measurement by the temperature measuring device. In addition, it may be possible as a result to dispense with calibration and/or adjustment of the temperature measuring device to different emissivities of the materials of the ULD.

In one embodiment, the method further includes the following steps: Comparison of the measured temperature of the ULD with a preset limit value and triggering of an alarm if the measured temperature exceeds the preset limit value. One advantage of this is that it is largely possible to dispense with manual monitoring of the temperature of the ULD. In addition, the alarm can also activate an automatic extinguishing system which nips the imminent fire or flames in the bud or at least keeps them small. Moreover, the alarm can draw the flight staff's attention to the fire or flames. The alarm can alert rescue workers on the ground that a fire has broken out or will soon break out in the aircraft and that therefore the aircraft will make an emergency landing.

The temperature measuring device can be calibrated and/or set to an emissivity of the material of the ULD, in particular of the material of the underside of the ULD, prior to the temperature measurement. The advantage of this is that the accuracy of the temperature measurement can be increased by taking the emissivity of different materials of the ULD into consideration. Consequently, the accuracy of the temperature measurement can essentially be kept constant even in the case of ULDs with different materials.

Further embodiments emerge from the subclaims. The invention will be explained in greater detail in the following on the basis of a drawing.

### BRIEF DESCRIPTION OF THE DRAWINGS

FIG. 1 shows a schematic lateral view of an embodiment of a cargo deck with roller drive units and containers according to the invention.

### DETAILED DESCRIPTION

The same reference numerals are used in the following description for identical parts and parts acting in an identical manner.

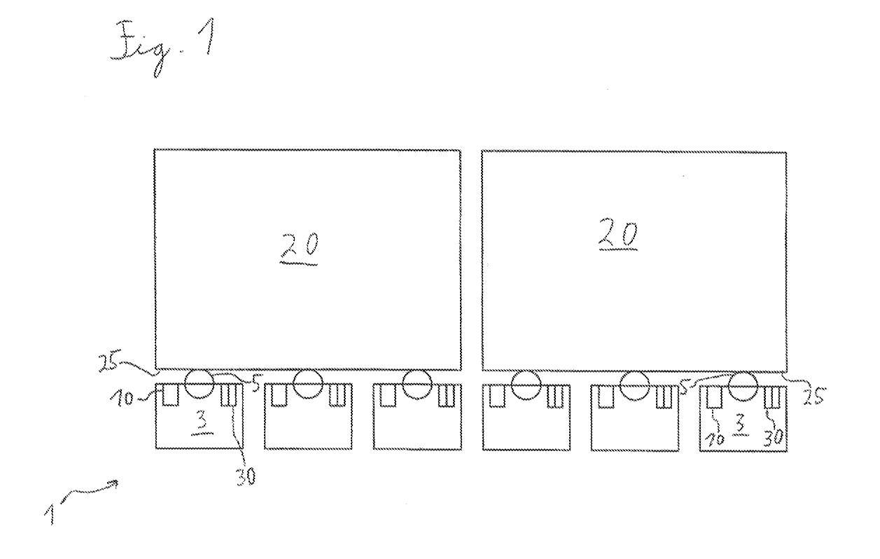

FIG. 1 shows a schematic lateral view of an embodiment of cargo deck 1 according to the invention. Cargo deck 1 comprises a plurality of roller drive units 3 which form a (part of a) cargo hold floor of cargo deck 1. Cargo deck 1 may form the upper and/or lower deck of an aircraft.

Roller drive unit 3 drives rollers 5 which can move the containers, pallets or similar ULDs (unit load device) 20. In FIG. 1, each of ULDs 20 is in contact via three rollers 5 in each case with one roller drive unit (PDU, power drive unit) 3 respectively. It is, however, conceivable that roller drive units 3 are disposed differently or that ULD 20 is in contact with a greater or smaller number of roller drive units.

Roller drive units 3 are arranged underneath ULDs 20 and form a part of the cargo hold floor. In FIG. 1, each of roller drive units 3 includes a temperature measuring device 10. It is also conceivable that only a proportion of roller drive units 3 each have a temperature measuring device 10.

Temperature measuring device 10 is arranged in the cargo hold floor in such a way that the temperature of an underside 25 of each ULD 20 can be recorded without physical contact.

Temperature measuring device 10 may be an infra-red camera and/or an infra-red sensor. Other types of non-contacting measurement of the container's temperature are conceivable.

In FIG. 1, temperature measuring device 10 measures the temperature of underside 25 of ULD 20. It is, however, also conceivable that temperature measuring device 10 is not disposed in roller drive unit 3 but at a different place in the cargo deck. In particular, it is conceivable that the temperature measuring device measures the temperature of a different side of the ULD, for example the temperature of the upper side or of a side wall of ULD 20. To do this, temperature measuring device 10 may, for example, be disposed in the ceiling of the cargo deck and/or in side walls of the cargo deck.

Temperature measuring device 10 measures the temperature of ULD 20. This may take place continuously or at intervals. The measured temperature measuring signals may be passed on to other devices. Temperature measuring device 10 is connected to a CAN bus for this purpose. Since roller drive units 3 are also generally connected to the CAN bus, it is very advantageous to dispose temperature measuring device 10 in roller drive unit 3. Via the CAN bus, the temperature measuring signals of temperature measuring device 10 can be further transmitted via a GSM/GPS interface. Other types of data connection of temperature measuring device 10 to other devices are conceivable.

Temperature measuring device 10 is connected via the CAN bus or other data connections to an operations control centre (OPCON) (not shown). The temperature measuring signals of a plurality of temperature measuring devices 10 come together in the operations control centre. The measured temperature is compared to a preset limit value, for example 150° C., in the operations control centre or in temperature measuring devices 10 themselves. An alarm is triggered if the measured temperature exceeds the preset limit value. As a result of the alarm, countermeasures can be taken to prevent the outbreak of a fire or flames or to extinguish the flame or fire. For example, the alarm can introduce extinguishing gases into the cargo deck or certain sections of the cargo deck can be isolated by means of fire protection walls. The alarm can draw the pilots' attention to the critical situation in the cargo deck and/or can alert rescue workers on the ground. The preset limit value may be set for different types of ULD 20 or different ULDs 20 can be set to different values.

Since different materials have different emissivities, temperature measuring device 10 is calibratable and/or adjustable to different emissivities. This ensures that, despite different materials, the accuracy of the temperature measurement by temperature measuring device 10 remains essentially constant.

Accuracy of the temperature measurement is understood to be how well the temperature measured by temperature measuring device 10 matches the actual temperature of ULD 20 or an outer side of ULD 20. The emissivity indicates how much radiation a body emits in relation to an ideal radiant heater in the shape of a black body.

ULDs 20 or undersides 25 of ULDs 20 are usually comprised of aluminum which has a low emissivity. It has proven particularly advantageous to provide underside 25 of ULD 20 with a surface coating in order to increase or standardize the emissivity. For example, underside 25 of ULD 20 may be colored black by anodization. Underside 25 of ULD 20 has an emissivity close to 1 due to the black coloration. This significantly increases the accuracy of the temperature measurement. This means that it is possible to dispense with calibration and/or adjustment of temperature measuring device 10 to different emissivities of various materials. Other type of surface coating, in particular painting of underside 25 of ULD 20 with black paint are conceivable. It is also conceivable that a side wall and/or the top of ULD 20 is provided with a surface coating. This is particularly expedient if the temperature measurement is to be carried out on a side wall or a top of ULD 20.

In FIG. 1, each roller drive unit 3 comprises a reflected light barrier 30 which has a transmitter and a receiver. The transmitter of reflected light barrier 30 transmits an infra-red signal which is reflected by underside 25 of ULD 20 if the ULD is located above relevant reflected light barrier 30 or roller drive unit 3. The receiver of reflected light barrier 30 receives the reflected infra-red light. The infra-red light is not reflected if there is no ULD 20 located above roller drive unit 3. The presence or absence of a ULD 20 is ascertained in this manner via relevant roller drive unit 3. This verification may be used to control roller drive unit or units 3.

In addition to measuring the temperature of ULD 20, temperature measuring device 10 may also be configured to ascertain the presence or absence of a ULD 20 above roller drive unit 3. To do this, temperature measuring device 10 transmits an output signal which is reflected by ULD 20. This may take place continuously or at intervals. Consequently, instead of two devices, a temperature measuring device 10 for measuring the temperature of ULD 20 and a reflected light barrier 30 for ascertaining the presence or absence of ULD 20, roller drive unit 3 may have only one such temperature measuring device 10 which fulfils both functions. This results in a reduction in costs and technical effort.

### LIST OF REFERENCE NUMBERS

1 Cargo deck
3 Roller drive unit (PDU)
5 Rollers of the roller drive unit (PDU)
10 Temperature measuring device
20 ULD (unit load device)
25 Underside of the ULD (unit load device)
30 Reflected light barrier unit

What is claimed is:

1. A cargo deck for a cargo hold of an aircraft comprising at least one temperature measuring device for non-contacting measurement of the temperature of at least one container, pallet or similar unit load device (ULD).

2. The cargo deck according to claim 1, wherein the temperature measuring device includes an infra-red sensor.

3. The cargo deck according to claim 1, wherein the temperature measuring device includes an infra-red camera.

4. The cargo deck according to claim 1, wherein the temperature measuring device is disposed in a floor of the cargo deck in such a way that the temperature of an underside of the ULD is measurable by means of the temperature measuring device.

5. The cargo deck according to claim 1, wherein the temperature measuring device is adapted for measuring the temperature of a substantially black underside of the ULD.

6. The cargo deck according to claim 1, wherein the temperature measuring device is connectable to a data bus, in particular a CAN bus, of the cargo deck, in particular of the cargo hold floor, for the transmission of heat measurement signals.

7. The cargo deck according to claim 1, wherein the temperature measuring device is connectable to an operations control centre.

8. The cargo deck according to claim 1, wherein the temperature measuring device can be calibrated and/or set to an emissivity of the material of the ULD, in particular of the material of the underside of the ULD.

9. The cargo deck according to claim 1, characterized by at least one roller drive unit (PDU) for moving the ULD, wherein the temperature measuring device is disposed in the roller drive unit.

10. The cargo deck according to claim 1, wherein the temperature measuring device is configured in such a way that the presence or absence of a ULD is ascertainable for control purposes by means of an output signal of the temperature measuring device.

11. A method for monitoring the temperature of a container, a pallet or a similar unit load device (ULD) disposed on a cargo hold floor, wherein the temperature of the ULD, in particular the temperature of an underside of the ULD, preferably the temperature of a black underside of the ULD, is measured without physical contact by means of a temperature measuring device, in particular by means of a temperature measuring device in a roller drive unit for moving the ULD of the cargo hold floor.

12. The method according to claim 11, wherein the temperature of the ULD is measured by means of an infra-red sensor and/or an infra-red camera.

13. The method according to claim 11, wherein prior to measuring the temperature, a surface coating is applied to an underside of the ULD to increase the emissivity.

14. The method according to claim 11, further including the following steps:
comparison of the measured temperature of the ULD with a preset limit value, and
triggering of an alarm if the measured temperature exceeds the preset limit value.

15. The method according to claim 11, wherein prior to the temperature measurement the temperature measuring device is calibrated and/or set to an emissivity of the material of the ULD, in particular of the material of the underside of the ULD.
